(19) United States
(12) Patent Application Publication
(10) Pub. No.: US 2007/0226401 A1
(43) Pub. Date: Sep. 27, 2007

(54) Data accessing structure and method for flash memory

(76) Inventors: Pa-Chung Huang, Tao-Yuan City (TW); Chien-Yin Liu, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/384,784

(22) Filed: Mar. 21, 2006

(51) Int. Cl. G06F 12/00; G06F 12/16

(52) U.S. Cl. 711/103; 711/162

(57) ABSTRACT

Data accessing structure and method for flash memory is disclosed. While data copying is performed in flash memory, a main controller assigns some of buffers as copy buffers; when data copying is not performed in flash memory, the main controller assigns all of buffers as data buffers. Therefore, all of buffers in a flash memory card are totally utilized.

### BACKGROUND OF THE INVENTION

1. Field of the Invention

The present invention generally relates to a structure and a method for accessing data stored in flash memory, and more particularly to structure and method for accessing data in flash memory by adaptively adjusting the function of buffers, according to a demand of data processing.

2. Description of the Prior Art

Flash memory, in the application of small memory card, is one of the popularly adopted components to repeatedly write data and preserve data without power. Recently, the popular specification of small flash memory card comprises: Compact Flash card (CF), Smart Media card (SM), Multimedia card (MMC), Memory Stick card (MS), Secure Digital card (SD), etc. The specification and contour of Secure Digital card and Multimedia card are similar, and both are generally applied to portable products of personal digital assistant (PDA), digital camera, cell phone, etc.

FIG. 1 shows a conventional data accessing structure of flash memory card. According to the specification of Secure Digital card and Multimedia card, when data are written via card reader 100 to flash memory 118, the data are controlled by and passed through the SD/MMC interface circuit 103, the SD/MMC data transfer controller 106, the microprocessor 109, the flash data transfer controller 112, flash interface circuit 115, data buffers 121, and copy buffers 124. In the conventional data accessing structure of a flash memory, a plurality of data buffers 121 are used to store data temporarily because the speed of data inputting to SD/MMC interface circuit 103 is higher than the speed of data writing to flash memory 118. For example, after the first data is received, the following data can keep being received by data buffers 121 when flash memory 118 is writing data, so that the process of data writing would not be paused. Due to the limitations of cost and chip size, the amount of data buffer can not be arbitrarily added.

According the data accessing rule of a flash memory, the data should be orderly written to a block page by page. Besides, the erase of data are also executed in the unit of block. Therefore, when the data are written from the data buffers 121 to the flash memory 118, on condition that the start writing address of data is just the start address of a block in the flash memory (as shown in FIG. 2A), the data would be directly written to the new block. FIG. 2B shows another example, on condition that the start writing address of data is not the start address of a block, the original data in the old block would be copied to another new block, and then the new data are written to the new block according to the start writing address of the new data. Finally, all of data in the old block are erased, so that the old block could be used as a new block hereafter.

Referring to FIG. 2C, when some data have stored in the old block, the original stored data would be copied to new block at first. Next, the new data would be written to new block according to the start writing address of the new data. If the new block were not full of data and the start writing address of the next data is not to continue to write to the new block, the remainder of the new block would copy the data of corresponding address in the old block. Finally, all of data in the old block are erased, so that the old block could be used as a new block hereafter.

In FIG. 1, copy buffers 124 comprise four copy buffers (1240, 1243, 1246, and 1249). The purpose of copy buffers 124 is to temporarily store data during the process of data copying from the old block to the new block. Because the data in the old block are often copied to the new block during the process of data writing, obviously, the copy buffers 124 are important part of data accessing structure in flash memory.

In general, the storing capacity of copy buffers 124 is more than the one of data buffers 121. However, the copy buffers 124 are not always in use, so that the resource of buffers is wasted. Besides, the storing capacity of data buffers 121 is often insufficient during data writing. So, a novel data accessing structure for flash memory, which is capable of increasing the capacity of data buffers and improving the utility rate of copy buffers without increasing cost and chip size, is needed.

### SUMMARY OF THE INVENTION

It is an object of the present invention to adaptively adjust the usage of buffers, so as to increase the temporary storing capacity and improving the data transmission rate.

It is another object of the present invention to increase the temporary storing capacity of data buffers without increasing the cost and chip size.

According to the object, the present invention provides a data accessing structure of flash memory comprising: a flash memory; a plurality of buffers, which are used to be data buffers for data reading/writing or be copy buffers for data copying; a main controller, coupled to said buffers, judges each of said buffers to be a copy buffer or a data buffer according to a read/write command provided by a memory card reading device; a memory card data transfer controller, coupled to said main controller, said memory card reading device and said buffers, reads data from or writes data in said buffers according to a first command provided by said main controller; and a flash data transfer controller, coupled to said main controller, said flash memory and said buffers, reads data from or writes data in said buffers according to a second command provided by said main controller.

### BRIEF DESCRIPTION OF THE DRAWINGS

FIG. 1 shows a conventional data accessing structure of flash memory;

FIG. 2A to 2C show diagrams of data writing/reading in flash memory;

FIG. 3 shows a data accessing scheme of one port accessing controller of flash memory in accordance with the first embodiment of the present invention;

FIG. 4 shows a data accessing structure of two ports accessing controller of flash memory in accordance with the second embodiment of the present invention; and

FIG. 5 shows a flow chart of the embodiments of present invention.

### DETAILED DESCRIPTION OF THE INVENTION

A data accessing structure and method for flash memory is disclosed in the present invention so as to speed up the data transmission rate. The present invention is not limited to NAND-type flash memory. Other types of flash memory are also suitable for present invention. The present invention could be also applied to different data accessing structures of flash memory, such as one port, multi-port, one-way, multi-way, etc.

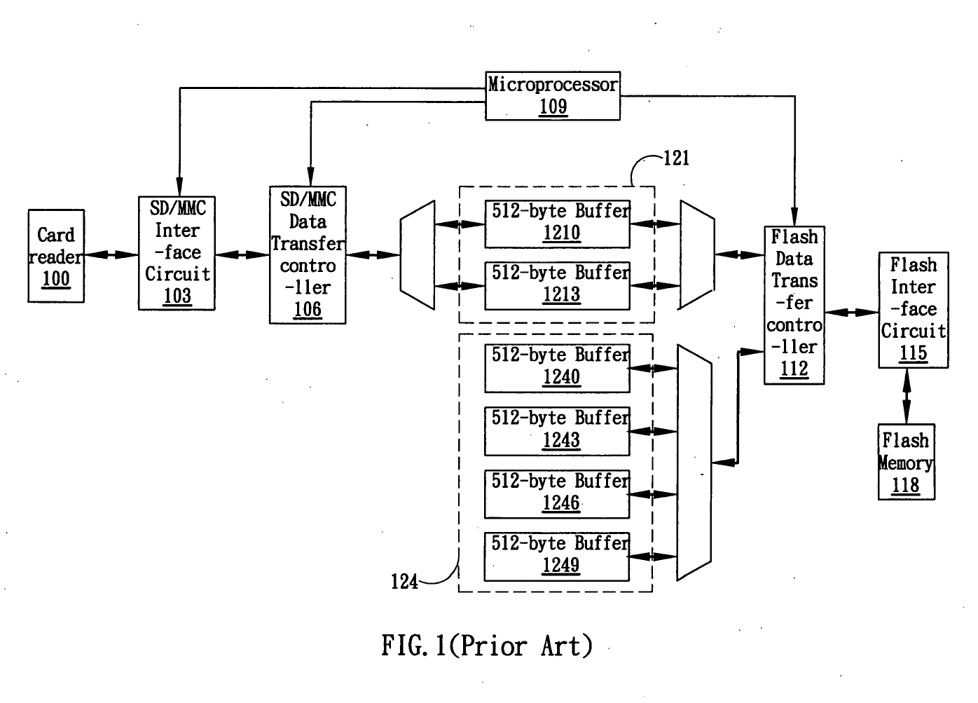

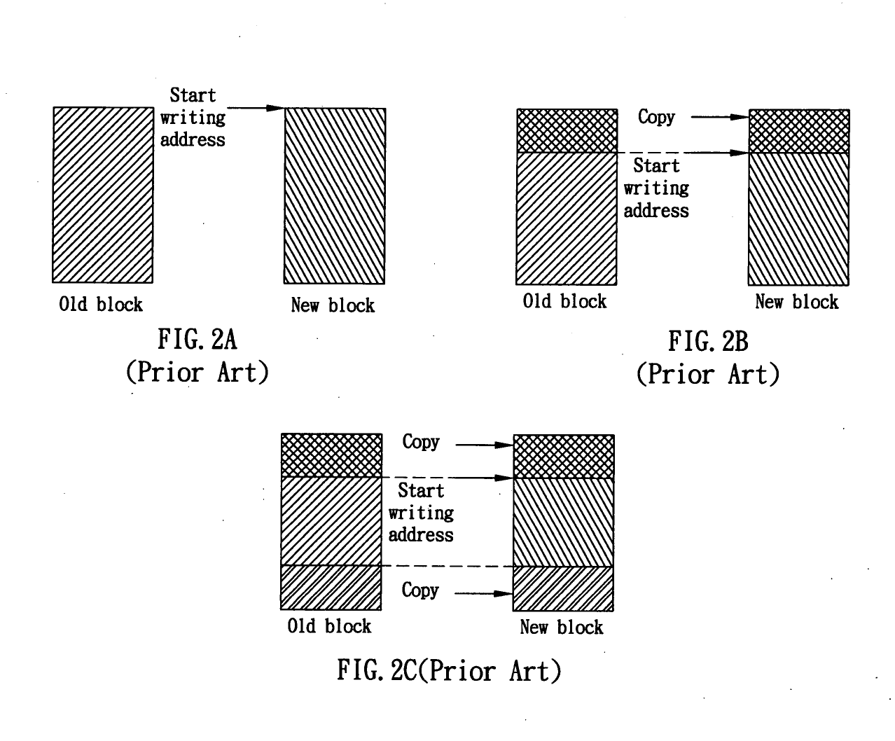

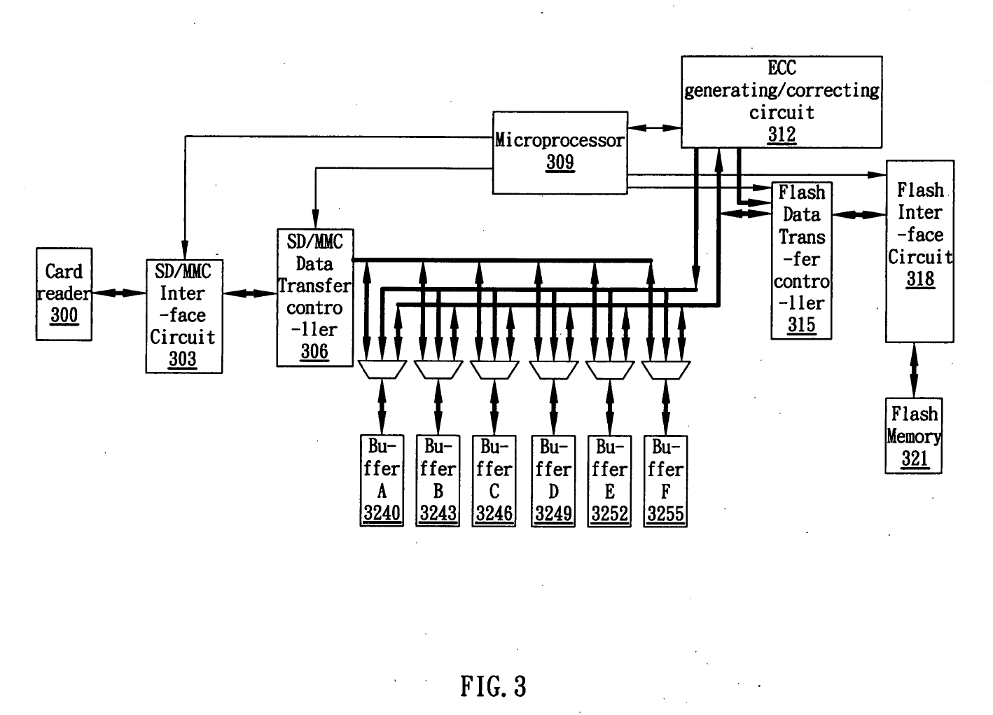

FIG. 3 shows a data accessing structure of one port of flash memory, which is a data accessing controller in accordance with a preferred embodiment of the present invention. The data accessing controller receives a read/write command from a flash memory card reading device, a card reader 300, to access data from a flash memory 321. In the present embodiment, the data accessing controller comprises, a SD/MMC interface circuit 303, SD/MMC data transfer controller 306, a main controller (for example, a microprocessor 309), an error correction code (ECC) generating/correcting circuit 312, a flash data transfer controller 315, a flash interface circuit 318, and six buffers A-F (3240, 3243, 3246, 3249, 3252, 3255). Compared with the conventional buffers in FIG. 1, the function of six buffers A-F (3240, 3243, 3246, 3249, 3252, 3255) in FIG. 3 are variable according to the demand.

In FIG. 3, when the data are written from the card reader 300 to the flash memory 321, all processes in the data accessing controller are described as follows. At first, microprocessor 309 judges whether or not copy buffers are needed during data writing; when copy buffers are needed during data writing, then buffers C-F (3246, 3249, 3252, 3255) are marked as copy buffers, and buffers A-B (3240, 3243) are marked as data buffers; when copy buffers are not needed during the data writing, or data copy process has been completed, then, all of buffers A-F (3240, 3243, 3246, 3249, 3252, 3255) are marked as data buffers.

During the processes of data writing, the function of each buffer is determined by microprocessor 309. Next, the microprocessor 309 notifies SD/MMC data transfer controller 306 of the function of each buffer, and controls the SD/MMC data transfer controller 306 to handle the data transmission between the buffers and card reader 300. The SD/MMC data transfer controller 306 handles the data transmission, which comprises the processes such as access bank select of buffers, reading/writing of buffer, data address, and transmission direction of data, etc. At the same time, the microprocessor 309 notifies flash data transfer controller 315 of the function of each buffer, and controls the flash data transfer controller 315 to handle the data reading/writing between the buffers and flash memory 321. The flash data transfer controller 315 handles the data transmission, which also comprises the processes such as access bank select of buffers, reading/writing of buffer, data address, and transmission direction of data, etc.

Besides, the microprocessor 309 would transmit a memory card status signal to SD/MMC interface circuit 303 during data writing, and then the signal is transmitted to the card reader 300 so as to provide the information of memory card to the card reader 300. Microprocessor 309 also controls the flash interface circuit 318 to set the type of flash memory 321 and the operation mode of flash memory 321 controlled by the flash interface circuit 318 (for example, write, read, copy, erase), and transmit a start writing address of data to flash memory 321 for data accessing.

During the processes of data writing, only data are transmitted between the SD/MMC data transfer controller 306 and SD/MMC interface circuit 303. When all of copy buffers are full of data, a busy signal provided by the SD/MMC data transfer controller 306 is transmitted to the card reader 300 through the SD/MMC interface circuit 303, so that the card reader 300 stop writing. Furthermore, during data writing, the microprocessor 309 notifies the flash data transfer controller 315 that the data in the buffers are prepared for writing to the flash memory 321. The microprocessor 309 controls the ECC generating/correcting circuit 312, then, the ECC generating/correcting circuit 312 generates corresponding error correction code (ECC) according to the data in the buffers; then the error correction code is transferred to the flash data transfer controller 315. When the data are stored to the flash memory 321, the ECC is also stored to the spare area of the flash memory 321 through the flash data transfer controller 315.

When the card reader 300 reads data from the flash memory 321, all of the steps are as follows: first, the function of buffers A-F (3240, 3243, 3246, 3249, 3252, 3255) are marked as data buffers by microprocessor 309 and secondly, the microprocessor 309 notifies SD/MMC data transfer controller 306 of the function of all buffers, and then further performs the processes such as access bank select of buffers, reading/writing of buffer, data address, and transmission direction of data, etc.

At the same time, the microprocessor 309 notifies flash data transfer controller 315 of the function of each buffer, and controls the flash data transfer controller 315 to handle the data transmission between the buffers and flash memory 321. The flash data transfer controller 315 handles the data transmission, which comprises the processes such as access bank select of buffers, reading/writing of buffer, data address, and transmission direction of data, etc.

During the data reading, the ECC generating/correcting circuit 309 is controlled by the microprocessor 309, and then the ECC generating/correcting circuit 309 checks whether the ECC, corresponding with the data read from the flash memory 321, is correct or not. If the ECC is correct, a signal is transmitted to notify the microprocessor 309. If the ECC is not correct, then the ECC generating/correcting circuit 312 would correct the data. If the ECC generating/correcting circuit 312 fails to correct the data, an ECC check error message is transmitted to notify the microprocessor 309. According to the signal transmitted by ECC generating/correcting circuit 312, the microprocessor 309 notifies the SD/MMC data transfer controller 306 that which one of the buffers A-F (3240, 3243, 3246, 3249, 3252, 3255) is ready to output data.

Furthermore, if the buffer is empty during the data reading, the SD/MMC data transfer controller 306 stop transmitting data to SD/MMC interface circuit 303. Equally, the microprocessor 309 would transmit a memory card status signal and the ECC check error message to SD/MMC interface circuit 303 during aforementioned reading process, and then the signal and the message are transmitted to the card reader 300 so as to provide the information of memory card and the correctness of data. The microprocessor 309 also monitors a command executing status responded by the flash memory 321 via the flash interface circuit 318.

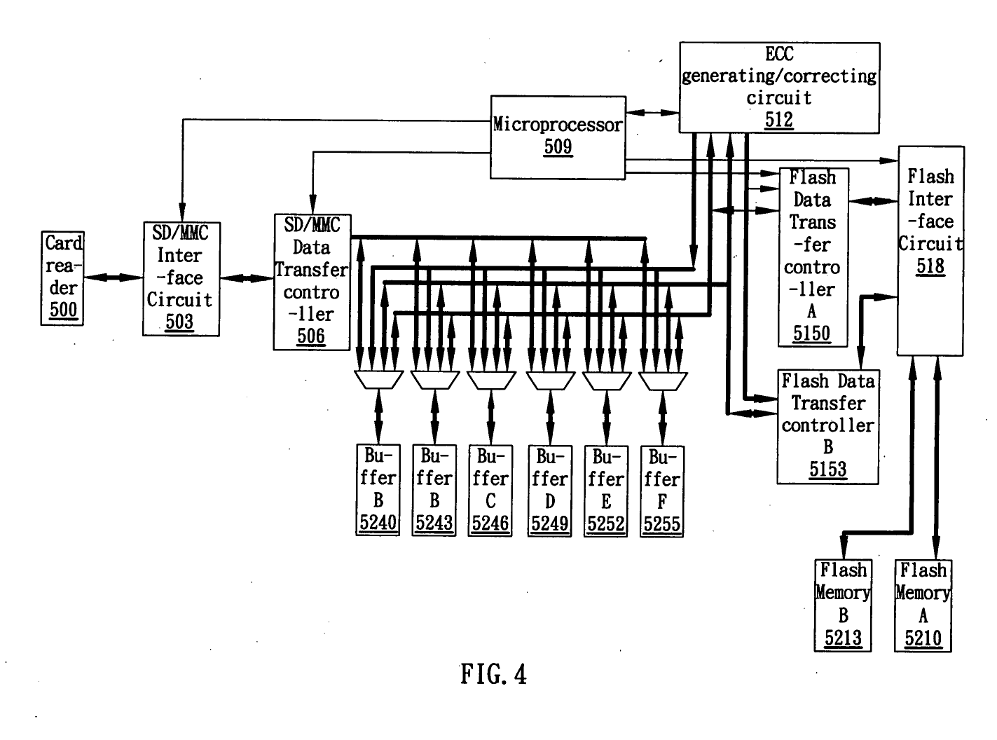

FIG. 4 shows a data accessing structure of two port of flash memory, which is a data accessing controller in accordance with another preferred embodiment of the present invention. The data accessing controller with two ports could access two flash memories. Compared with the structure in FIG. 3, the present embodiment comprises that the flash data transfer controller A 5150 and the flash data transfer controller B 5153 control the flash memory A 5210 and the flash memory B 5213 respectively, through the flash interface circuit 518. Hence, the data accessing rate could be speeded up. Due to the control of signal and the transmission of data among the flash data transfer controller A 5150, flash data transfer controller B 5153, ECC generating/correcting circuit 512, microprocessor 509, flash interface circuit 518 and all of buffers A-F (5240, 5243, 5246, 5249, 5252, 5255) are similar to the statement of FIG. 3, the description would not be repeated here.

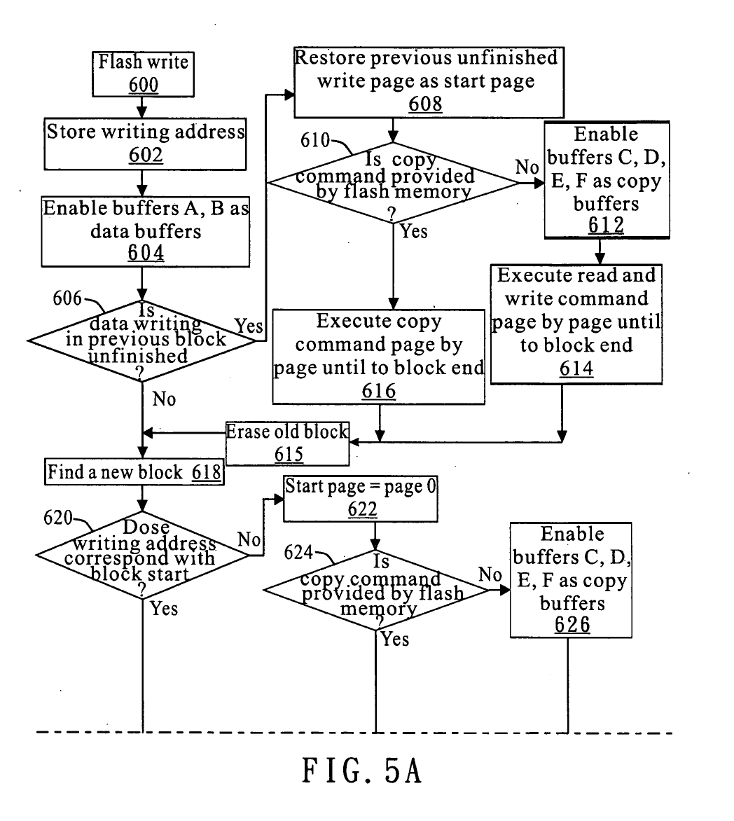

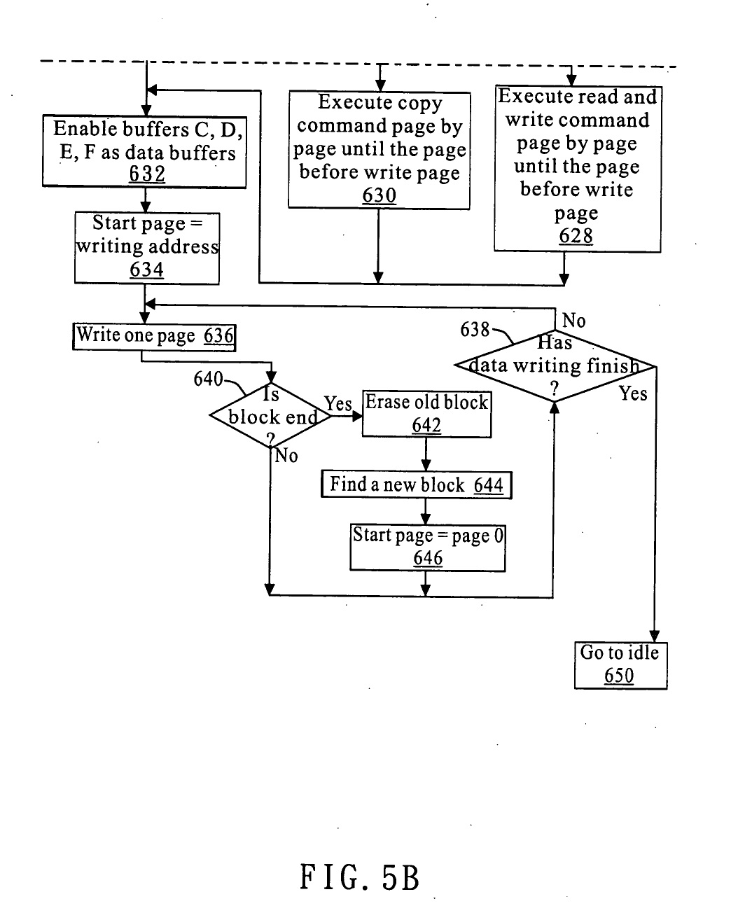

FIG. 5 shows a flow chart of data writing in accordance with present invention, so as to describe the change timing, which some data buffers become copy buffers. In general, the basic unit of data writing is one page, and the size of one page could be 512 bytes or 2 K bytes, depending on the specification of flash memory. The basic unit of data erasing is one block, and one block could comprise 32 pages, 64 pages or more pages. In FIG. 5, a write command is send by the card reader at first (step 600); in step 602, the writing address of data is stored. Next, the buffers A and B are enabled as data buffers so as to temporarily store the transmitted data from card reader (step 604). Following step 604, step 606 judges whether the data writing in previous block is unfinished or not. When the data writing is unfinished, the step 608 is performed; otherwise, the step 618 is performed. In step 608, a write page in the previous unfinished block is restored to be a start page for data writing. Following step 608, step 610 judges whether a copy command is provided by the flash memory or not (some flash memory do not provide a copy command, but the function of copy could be achieved by read command and write command). When the copy command is not provided by the flash memory, the step 612 is performed. On the contrary, the step 616 is performed. In step 612, the buffers C-F are enabled as copy buffers, and then in step 614, the data in the old block are copied to a new block page by page until to the block end by using the read command and write command. In step 616, the data in the old block are copied to a new block page by page until to the block end by using the copy command. Either the step 614 or step 616 is performed, the step 615 is performed to erase the data in the old block. Next, the step 618 is performed.

In step 618, finding a new block for writing data. In step 620, judging whether the previous writing address corresponds with the start of the block or not. When the previous writing address corresponds with the start of the block, step 632 is performed; otherwise, step 622 is performed. In step 622, the start page of data is set to correspond with the start page (page 0) of a new block for preparing to copy data. Following step 622, step 624 judges whether a copy command is provided by the flash memory or not. When the copy command is not provided by the flash memory, the step 626 is performed. On the contrary, the step 630 is performed. In step 626, the buffers C-F are enabled as copy buffers, and then in step 628, the data are copied to a new block page by page until the page before the writing page by using the read and write command. The foregoing writing page means that the page corresponds with the previous writing address. In step 630, the data are copied to a new block page by page until the page before the writing page by using the copy command. Either the step 628 or step 630 is performed, the step 632 is performed.

In step 632, the buffers C-F are enabled as data buffers. In step 634, the page corresponded with the previous writing address is set as start page of data writing. In step 636, writing data to the new block in the unit of page, and then in step 640, judging whether the data are written to the block end or not. When the data are written to the block end, step 642 is performed; otherwise, step 638 is performed. In step 642, the data in the old block are erased, so as to write data hereafter. Following step 642, step 644 finds another new block for preparing to write data. In step 646, the start page of data is set to correspond with the start page (page 0) of new block. Following step 640 or step 646, step 638 judges whether all data writing has finished or not. When data writing has finished, the data accessing structure of the present invention stays in idle status (step 650). Otherwise, step 363 is performed. According to foregoing description, all of buffers are used to be data buffers if the flash memory provides copy command; On the contrary, some buffer are used to be copy buffers if the data copying is performed but the flash memory does not provide copy command.

Although specific embodiments have been illustrated and described, it will be appreciated by those skilled in the art that various modifications may be made without departing from the scope of the present invention, which is intended to be limited solely by the appended claims.

What is claimed is:

1. A data accessing structure for flash memory, comprising:
a flash memory card reading device;
a flash memory;
a plurality of buffers, which are used to be data buffers for data reading/writing or be copy buffers for data copying;
a main controller, coupled to said buffers, decides each of said buffers to be said copy buffer or said data buffer according to a read/write command provided by said flash memory card reading device;
a data transfer controller, coupled to said main controller, said flash memory card reading device and said buffers, receives a first command from said main controller for reading or writing data in said buffers according to said first command; and
a flash data transfer controller, coupled to said main controller, said flash memory and said buffers, receives a second command from said main controller for reading or writing data in said buffers according to said second command.

2. The structure of claim 1, further comprising:
an memory card interface circuit, coupled between said flash memory card reading device and said data transfer controller, receives a memory card status signal provided by said main controller and then transfers to said flash memory card reading device.

3. The structure of claim 2, wherein said data transfer controller sends a notify signal to notice said interface circuit, when said buffers are full of data or said buffers are empty without any data to be read.

4. The structure of claim 1, further comprising:
a flash interface circuit, coupled between said flash data transfer controller and said flash memory, receives a operation command provided by said main controller to set the type of said flash memory, and decide a operation mode to flash memory.

5. The structure of claim 4, wherein said operation mode is one of following operation modes: write, read, copy, and erase.

6. The structure of claim 1, further comprising:
an error correction code (ECC) generating/correcting circuit, which generates error correction codes and then store to said flash memory during data writing; or checks whether said error correction codes outputted from said flash memory are correct or not during data reading.

7. The structure of claim 1, wherein said main controller comprises a microprocessor.

8. A data accessing method for flash memory, comprising:
judging whether needing to perform data copying during the data accessing in a flash memory or not;
assigning some of buffers as copy buffers if said data copying is needed in said flash memory; and
assigning all of said buffers as data buffers if said data copying is not needed in said flash memory.

9. The method of claim 8, further comprising:
transferring a memory card status to a flash memory card reading device, when said buffers are full of data or said buffers are empty without any data to be read.

10. The method of claim 8, further comprising:
generating error correction codes and then store to said flash memory during data writing; and
checking whether said error correction codes outputted from said flash memory are correct or not during data reading.
